(19) United States
(12) Patent Application Publication
(10) Pub. No.: US 2010/0188326 A1
(43) Pub. Date: Jul. 29, 2010

(54) Ornamental thumb or finger ring with secured hidden contact interface input device

(76) Inventor: Steven A. Dines, Freeport, PA (US)

Correspondence Address: RONALD S. LOMBARD, ESQUIRE, 4430 TWIN OAKS DRIVE, MURRYSVILLE, PA, 15668, US

(21) Appl. No.: 12/321,822

(22) Filed: Jan. 26, 2009

(51) Int. Cl. G09G 5/00

(52) U.S. Cl. 345/156

(57) ABSTRACT

An ornamental thumb or finger secured contact interface input device includes a thumb or finger ring that has a rotatable stylus operatively attached to the ring. The stylus includes an elongated retractable interface contact member including a text tap portion for contacting an interface and entering data. The contact member is retractable into a rotabable housing in a hidden ornamental mode and is fully extendable in an interface engaging mode for entering input into an electronic interface device. The ring is non-continuous and includes an opening and is bendable so that may be appropriately sized to the thumb or finger of a user. The device can function as a stylus for inputting an interface in the interface engaging mode or be worn as an item of jewelry in the hidden ornamental mode.

### BACKGROUND OF THE INVENTION

The present invention relates to a contact interface input device, and, in particular, to a thumb or finger ring with a secured contact interface input device. Interface input devices, such as, as touch screens on personal digital assistants (PDA's), keyboards on cell phones and many other types of electronic based interface input devices are activated by physical contact with the interface. The interfaces typically have discreet touch areas or buttons that simulate keys like that of a computer keyboard or calculator for a user's contact with his or her fingers or thumb. Often these discreet touch areas or buttons are very small and often difficult for many users to easily and accurately touch the desired touch area or button. This is even more evident for users that are partially restricted with the use of their fingers or thumbs because of age, disease or some other handicap or have large hands. In recent years, for example, cell phone text messaging has become quite popular and requires the cell phone user to use his or her fingers or thumbs to input the desired text into the device. For many users the keys or buttons are quite small and difficult to consistently and accurately contact. A stylus, usually in the shape of a pencil or pen, has been used in such cases as a contact interface input device. Such a stylus for example is commonly used in check-out aisles of stores attached to credit card interface devices to aid customers in pushing discreet touch areas of such devices and also for entering the customer's signature into the electronic device. A concern with such public styluses and discreet touch areas for use by the public is that they are known to carry germs such as bacteria and viruses that may be easily spread from person to person.

In recent years a number of patents have issued relating to such styluses adapted to be worn on a user's finger. One such finger mounted stylus is disclosed in U.S. Pat. No. 6,075,189 issued Jun. 13, 2000 to Karl A. Robb. The Robb patent discloses an operator or artificial finger tip for entering commands into a personal data device. The operator comprises a partially rigid base which encircles the finger and a rigid tip member which projects forwardly from the base to contact the screen. The tip member is provided with a snap fitting connector enabling it to be manually and removably attached to the base. Another such finger mounted stylus is disclosed in U.S. Pat. No. 6,225,988 B1 issued May 1, 2001 to Karl Robb. This second Robb patent discloses a screen operator or artificial finger tip for entering commands and data into a personal data device. The screen operator includes a partially rigid base that encircles the finger, and a rigid tip member which projects forwardly from the base to contact the screen. The base is tubular preferably with a gap and resiliently grips the finger. A hook member extends downwardly and back from the tip member to engage the underside of the user's finger tip.

Another such finger mounted stylus is disclosed in U.S. Pat. No. 6,249,277 B1 issued Jun. 19, 2001 to Nicholas G. Varveris. The Varveris patent discloses a finger stylus including a flexible non-metallic elastic ring or a flexible, fabric-like strap having distal ends, each of the distal ends includes parts of an interconnect fastener such as hooks and loops or a magnetic fastener. The ring or strap forms a wraparound for a human fingertip. By bending the interconnect fastener parts about the fingertip or the elasticity of the ring firmly hold the strap against the fingertip. The ring or strap includes an intermediate portion including a loop-hole extending from an exterior surface of the intermediate portion which receives a longitudinal stylus rod extending through the loophole in a semi-friction-fit connection with the loophole.

Still another such finger mounted stylus is disclosed in U.S. Pat. No. 6,527,464 B2 issued Mar. 4, 2003 to Winston Delano Lee. The Lee patent discloses a multi-purpose fingertip pen/stylus comprising a flexible shaft having first and second ends made of a bendable material, which retains a twisted shape. The shaft is sized of sufficient length to wrap and secure about the fingertip of a writing digit or be used in a straightened position as a conventional pen. The stylus includes a first end adapted as a stylus tip for use with pressure sensitive computer screens, and a second end adapted as a writing tip to extend sufficiently beyond the fingertip of the writing digit stylus to contact and write on a writing surface.

U.S. Pat. No. 6,587,090 B1 issued Jul. 1, 2003 to Eli D. Jarra discloses a stylus computer device that includes an input mechanism that is secured to the finger tip pad of a user's index finger. In one embodiment, the computer input device includes a splint structure, a fingertip strap assembly attached to the tip end of the splint structure.

Yet still another such finger mounted stylus is disclosed in U.S. Pat. No. 6,626,598 B2 issued Sep. 30, 2003 to Marc L. Schneider. The Schneider patent discloses an adjustable and economical finger stylus useful in operating a touch sensitive screen and for entering data, in for example, a personal digital assistant (PDA). The Schneider stylus in one embodiment includes a longitudinal element having an upper surface adapted to be positioned parallel to and in touching contact along a lower surface portion of a user's finger. The stylus further provides for the longitudinal element to curve upwardly from lower surface portion of a user's finger adjacent the finger tip and terminates proximate the finger nail. The longitudinal element further includes one adjustable, flexible finger engaging element extending outwardly from each side of the longitudinal element and ending in a free end. A tapered writing extension extends longitudinally from the curved element and forward the finger nail.

The foregoing references all disclose various finger mounted styluses but in general do not disclose a finger stylus for continual daily wear that is attractive and may be worn as an item of ring jewelry when not in use. In addition, the references fail to disclose a stylus that includes a text tap that may be substantially hidden when not in use but remain attached to the ring to prevent its being lost or misplaced. These possible deficiencies of the foregoing references are overcome by the present invention.

### SUMMARY OF THE INVENTION

The present invention discloses an ornamental thumb or finger ring secured contact interface input device. The device includes a thumb or finger ring having an inner surface for contacting a thumb or finger of a user in operable position. The ring has a substantially parallel pair of brackets extending outwardly from the outer surface of the ring proximate the bottom thereof at the underside of the thumb or finger of a user in the operable position. A stylus is rotably mounted between the bracket pair. The stylus is rotatable between an interface engaging mode and a hidden ornamental mode. The stylus includes an elongated hollow housing and an elongated slideable retractable interface contact member, slideably secured within the hollow housing, whereby the retractable interface contact member may be substantially withdrawn into the housing when the stylus is in the hidden ornamental mode and may be extended from the housing for contact with an interface for entering interface input when said stylus is rotated to the interface engaging mode.

Preferably, the ring comprises a bendable material and is desirably formed as a non-continuous ring having ends which are separable from one another at an opening in the non-continuous ring at a point opposite the bracket pair. The bendable material being of sufficient flexibility to permit bending of the ring for sizing the ring to the user's thumb or finger and the bendable material being of sufficient rigidity to maintain the user's thumb or finger size for the ring once sized, whereby different thumb or finger sizes may be accommodated by expanding or contracting the effective ring diameter as desired by the user.

Preferably, the opening in the non-continuous ring is substantially aligned with the midpoint of the upperside of the thumb or finger of the user in the operative position. Also, the ring has ring ends which are complimentary longitudinal triangular end portions.

Desirably, the hollow housing has an upper rectangular side and a lower rectangular side. An elongated retractable interface contact member is provided which has a stop extending perpendicularly from the elongated interface contact member proximate one end thereof closest to the brackets. The housing is provided with an elongated slot in the lower rectangular side for operatively receiving the stop. The stop is slideable within the slot, whereby when the contact member is not in use in the hidden ornamental mode and is retracted substantially into the housing the stop is restrained by one end of the slot of the housing and when the contact member is fully extended in the interface engaging mode the stop is restrained by the other end of the slot to secure the contact member within said housing.

Desirably the housing is comprised of separable upper and lower sections. The upper section of said housing preferably has a U-shaped extension portion comprising resilient first and second fingers. Each of the first and second fingers having ring engagement pins extending transversely on the outer side of the U-shaped extension portion. The parallel pair of brackets each has an oppositely disposed recess therein for receiving one of said ring engagement pins.

The housing is preferably provided with an opening at one end thereof opposite the brackets. The elongated retractable interface contact member slideably extends through the opening. The elongated retractable interface contact member includes a text tap portion extending transversely therefrom proximate the other end of the contact member exterior from the housing in a direction substantially perpendicular to the underside of the user's thumb or finger in the operative position, whereby the elongated retractable interface contact member in the interface engaging mode is fully extended and may be used by the user to physically contact an interface input device.

Preferably the U-shaped extension portion of the upper section of the housing is a frictional fit and in frictional contact with the pair of brackets, whereby due to friction forces the elongated retractable interface contact member remains in the interface engaging mode or the hidden ornamental mode until physically rotated by the user.

It is desirable that the ring is made of at least one of plastic or metal. Preferably, the ring if made of metal is made of metal comprising silver, gold, steel or aluminum alloy. Alternatively, the ring may be made of a base metal covered with an outer layer comprising silver or gold. Preferably the housing is plastic, but may be metal if desired.

### BRIEF DESCRIPTION OF THE DRAWINGS

For a better understanding of the invention, reference may be made to the accompanying drawings exemplary of the particular embodiments of the invention, where:

FIG. 1 is a side view of the ornamental thumb or finger secured contact interface input device in operative position on a user's thumb showing the retractable interface contact member in both the extended interface engaging mode and retracted (dashed lines) prior to the housing being rotated to the hidden ornamental mode;

FIG. 2 is a bottom view of the device of the present invention;

FIG. 3 is a plan view of the device as shown in FIG. 2;

FIG. 4 is a side view of the device as shown in FIG. 3 with the housing and retractable interface contact member drawn partially in phantom and shown rotated 90 degrees with respect to the ring to a rotation of 270 degrees with respect to the ring;

FIG. 5 is a plan view of the device taken along the line 5-5 of FIG. 4 with the housing and retractable interface contact member rotated 270 degrees with respect to the ring;

FIG. 6 is a bottom view of the device taken along the line 6-6 of FIG. 4 with the housing and retractable interface contact member rotated 90 degrees with respect to the ring;

FIG. 7 is a top view of the ring of the present invention showing the opening shown in FIG. 1 and the complimentary longitudinal triangular end portions; and,

FIG. 8 is an exploded isometric view of the device of the present invention.

### DETAILED DESCRIPTION OF THE PARTICULAR EMBODIMENTS

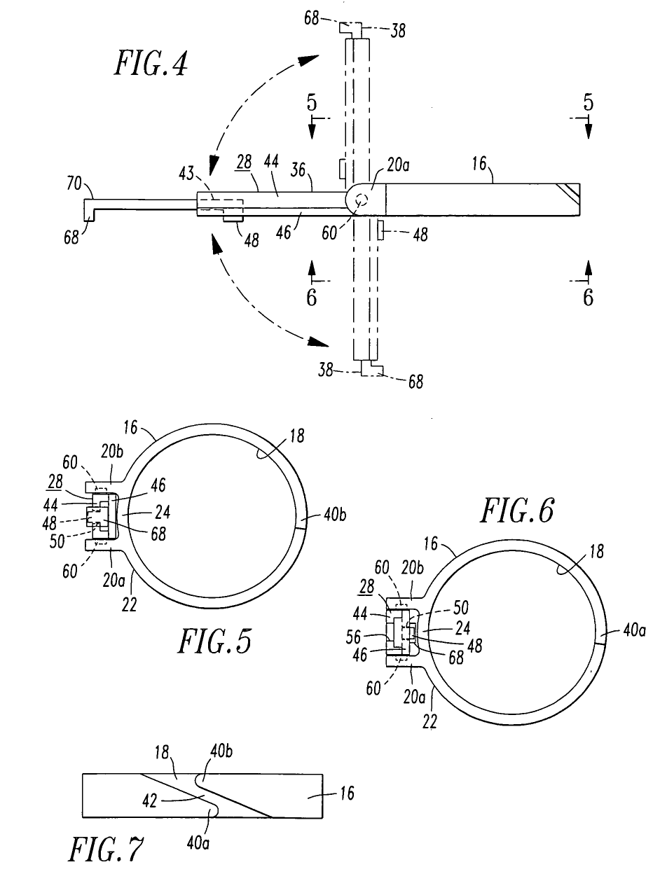

With reference to FIG. 1, there is shown an ornamental thumb or finger secured contact interface input device 10 of the present invention. For illustration purposes, a partial thumb 12 of a user is depicted in FIG. 1 showing the device 10 engaging the distal end 14 of the thumb 12. The device 10 includes a thumb or finger ring 16 having an inner surface 18, as a typical jewelry ring, for contacting a thumb or finger, as desired, of a user. The ring preferably has an integral pair of substantially parallel brackets 20a, 20b extending outwardly from the outer surface 22 of the ring 16 near the bottom 24 thereof at the underside 26 of the thumb 12 (or finger) of the user. A stylus 28 is rotatably mounted at one end 30 thereof between the brackets 20a, 20b. As can be seen in FIG. 1 the stylus 28 is rotatable between an interface engaging mode 31 in which the distal end of the stylus engages an interface 32 in operative position and a hidden ornamental mode 34 in which the stylus 28 is rotated more than 180 degrees as shown in FIG. 1 to contact the underside 26 of the user's thumb 12. The stylus 28 includes an elongated rectangular hollow housing 36 and an elongated slideable retractable interface contact member 38 slideably secured within the hollow housing 36. The present invention provides the retractable interface contact member 38 the capability to be substantially retracted into the housing 36 when it is desired that the stylus 28 be rotated to the hidden ornamental mode 34 when the stylus is not in use. In this way, the stylus 28 not being separable from the ring 16 will not be misplaced. For use of the stylus 28 the stylus is rotated by the user from the hidden ornamental mode 34 shown in FIG. 1 to the interface engaging mode 31 and the elongated interface contact member 38 is fully extended by the user as shown in FIGS. 1-3 and FIG. 4.

A further aspect of the present invention provides that the ring 16 comprises a bendable material. Preferably it is made of at least one of a plastic such as acrylonitrile butadiene styrene (ABS) plastic or metal comprising an alloy of silver, gold, steel, or aluminum. Alternatively, the ring may be made of a base metal such as stainless steel covered with an outer layer comprising silver or gold. The object is to make the ring 16 both attractive to be worn on a regular basis by the user like any other piece of jewelry while at the same time be able to function as a stylus as an input to an interface. In addition to the ring 16 being comprised of a bendable material, it is also desirable that the ring 16 be formed as a non-continuous ring, that is, having ends 40a, 40b as shown in FIGS. 1-5 and FIG. 7, which are separable by the user from one another at an opening 42 as shown in FIGS. 1 and 7 at a point opposite the bracket pair 20a, 20b, for example. Preferably, the ring ends 40a, 40b are complimentary longitudinal triangular end portions as shown in FIG. 7.

The bendable material of the ring 16 permits sufficient flexibility to permit bending of the ringing for sizing the ring 16 to substantially any portion, that is, circumference of the user's thumb 14 (or finger). Thus, the ring may be worn in the position on the user's thumb 14 as depicted in FIG. 1 for using the stylus 28 for inputting the interface 32 and then in the hidden ornamental mode 34 may be adjusted by the user to fit another portion of the thumb 12 as desired by the user. The bendable material also has sufficient rigidity to maintain the user's thumb or finger size once the ring is positioned as desired. This feature of the invention also permits users of varying thumb and finger sizes to be accommodated by simply expanding or contracting the effective ring diameter as desired by the user or left by the user in the same position. Preferably, the opening 42 in the ring 16 is substantially aligned with the midpoint of the upper side of the thumb 12 or finger of the user in the operative position as shown in FIG. 1.

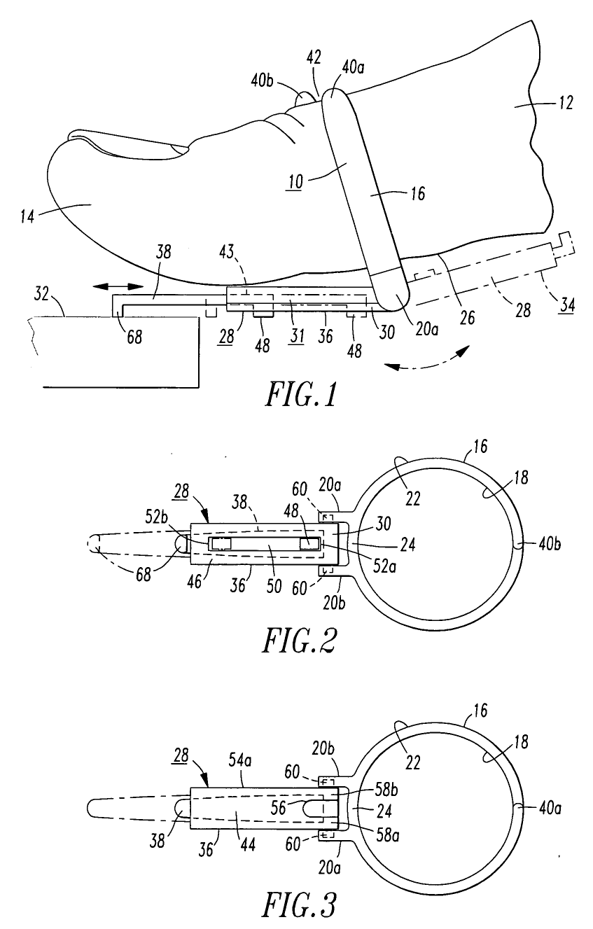

The elongated hollow housing 36 has an upper rectangular side 44 and lower rectangular side 46 as shown in FIGS. 2, 3 and 8. The elongated interface contact member 38 preferably has an integral stop 48 at one end 43 thereof extending perpendicularly from the elongated interface contact member 38 as shown FIGS. 1 and 2 for example. The housing 36 has an elongated slot 50 in the lower rectangular side 46 for operatively receiving the stop 48 as shown in FIG. 2. The stop 48 is slideable within the slot 50. When the contact member 38 is not in use in the hidden ornamental mode 34 and is retracted substantially into the housing 36 the stop 48 is restrained by one end 52a of the slot 48 and when the contact member 38 and if fully extended in the interface engaging mode 31 the stop 48 is restrained by the other end 52b of the slot 50 to secure the contact member within the housing 36 as shown in FIG. 2.

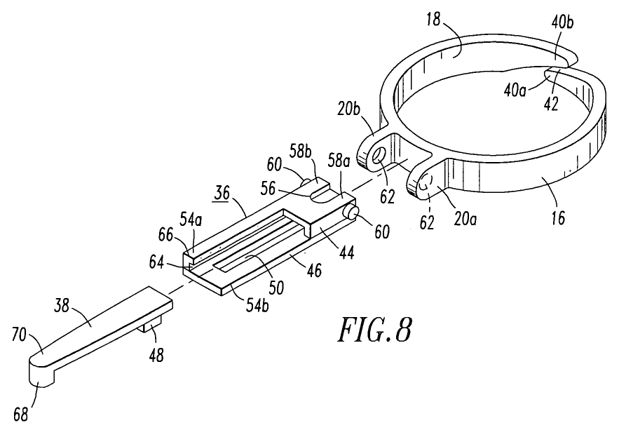

It is been found expedient that the housing 36 be comprised of a separable upper section 54a and a separable lower section 54b as shown in FIG. 8. The upper section 54a of the housing 36 has a U-shaped extension portion 56 including a resilient first finger 58a and a resilient second finger 58b. Preferably, the stylus 28 with the U-shaped extension portion 56 of the supper section 54a of the housing 36 is in sufficient frictional contact with the brackets 20a, 20b so that the interface contact member 38 remains in the interface engaging mode 31 or the hidden ornamental mode 34 until the stylus 28 is physically rotated by the user. The first finger 58a and the second finger 58b each have a cylindrical ring bracket engagement pin 60 extending perpendicularly therefrom. Each of the brackets 20a, 20b have an oppositely disposed cylindrical recess 62 for receiving the engagement pins 60. The resiliency of fingers 58a and 58b permit the U-shaped extension portion 56 of the upper section 54a to be momentarily squeezed towards each other while inserting it between the brackets 20a and 20b and aligning the pins 60 with the recesses 62 and then releasing the U-shaped portion 56 so that the pins 60 may rotatably engage the brackets 20a, 20b at the recesses 62. The interface contact member 38 may then be aligned with the upper section 54a and the lower section 54b may be attached to the upper section 54a by a suitable adhesive as shown in FIG. 8. When the upper section 54a and the lower section 54b are attached an entrance opening 64 at other end 66 of the housing 36 opposite the brackets 20a, 20b is formed. The interface contact member 38 extends through the entrance opening 64.

The elongated retractable interface contact member includes a text tap portion 68 extending transversely therefrom at the other end 70 of the contact member 38 exterior of the housing 36 in a direction substantially perpendicular to the underside 26 of the user's thumb 12 or finger in operative position. The text tap portion 68 can be used when the contact member is fully extended in the interface engaging mode 31 by the user to physically contact an interface 32, such as a personal digital assistant screen or cell phone keyboard, to input information as desired.

Preferably, the stylus 28 with the U-shaped extension portion 56 of the upper section 54a of the housing 36 is in sufficient frictional contact with the brackets 20a, 20b so that the interface contact member 38 remains in the interface engaging mode 31 or the hidden ornamental mode 31 until the stylus 28 is physically rotated by the user.

Although the present invention is described in reference to the foregoing particular embodiments, it should be understood that various changes and/or modifications can be made without departing from the scope of the invention.

What is claimed is:

1. An ornamental thumb or finger secured contact interface input device, said device comprising:
a thumb or finger ring having an inner surface for contacting a thumb or finger of a user in operable position, said ring having a substantially parallel pair of brackets extending outwardly from the outer surface of the ring proximate the bottom thereof at the underside of the thumb or finger of a user in the operable position, a stylus rotably mounted between said bracket pair, said stylus rotatable between an interface engaging mode and a hidden ornamental mode, said stylus including an elongated hollow housing and an elongated slideable retractable interface contact member slideably secured within said hollow housing, whereby said retractable interface contact member may be substantially retracted into said housing when said stylus is in the hidden ornamental mode and may be extended from said housing for contact with an interface for entering interface input when said stylus is rotated to the interface engaging mode.

2. The ornamental contact interface input device of claim 1, wherein said ring comprises a bendable material.

3. The ornamental contact interface input device of claim 2, wherein said ring is formed as a non-continuous ring having ends which are separable from one another at an opening in said non-continuous ring at a point opposite said bracket pair, and said bendable material being of sufficient flexibility to permit bending of the ring for sizing the ring to the user's thumb or finger and said material being of sufficient rigidity to maintain user's thumb or finger size for the ring once sized, whereby different thumb or finger sizes may be accommodated by expanding or contracting the effective ring diameter as desired by the user.

4. The ornamental contact interface input device of claim 3, wherein said opening in said non-continuous ring is substantially aligned with the midpoint of the upperside of the thumb or finger of the user in the operable position.

5. The ornamental contact interface input device of claim 4, wherein said ring ends are complimentary longitudinal triangular end portions.

6. The ornamental contact interface input device of claim 1, wherein said hollow housing has an upper rectangular side and a lower rectangular side, an elongated retractable interface contact member has a stop extending perpendicularly from said elongated interface contact member proximate the one end thereof closest to said brackets, said housing having a elongated slot in the lower rectangular side for operatively receiving said stop, said stop slideable within said slot, whereby when the contact member is not in use in the hidden ornamental mode and is retracted substantially into the housing the stop is restrained by one end of the slot of the housing and when the contact member is fully extended in the interface engaging mode the stop is restrained by the other end of the slot to secure the contact member within said housing.

7. The ornamental contact interface input device of claim 7, wherein said housing is comprised of separable upper and lower sections.

8. The ornamental contact interface input device of claim 7, wherein upper section of said housing has a U-shaped extension portion comprising resilient first and second fingers, each of said first and second fingers having ring engagement pins extending transversely on the outer side of the U-shaped extension portion, said parallel pair of brackets each having an oppositely disposed recess therein for receiving one of said ring engagement pins.

9. The ornamental contact interface input device of claim 6, wherein said housing has an entrance opening at the other end thereof opposite said brackets, said elongated retractable interface contact member slideably extending through said entrance opening, said elongated retractable interface contact member including a text tap portion extending transversely therefrom proximate the other end of said contact member exterior from said housing in a direction substantially perpendicular to the underside of the user's thumb or finger in the operable position, whereby the elongated retractable interface contact member in the interface engaging mode is fully extended and may be used by the user to physically contact an interface.

10. The ornamental contact interface input device of claim 8, wherein said U-shaped extension portion of said upper section of said housing is in frictional contact with said pair of brackets, whereby due to friction forces said elongated retractable interface contact member remains in the interface engaging mode or the hidden ornamental mode until the stylus is physically rotated by the user.

11. The ornamental contact interface input device of claim 2, wherein said ring is comprised of at least one of plastic or metal.

12. The ornamental contact interface input device of claim 11, wherein said ring is comprised of metal comprising silver, gold, steel or aluminum alloy.

13. The ornamental contact interface input device of 11, wherein said ring is comprised of a base metal covered with an outer layer comprising silver or gold.

14. The ornamental contact interface input device of claim 1, wherein said housing is comprised of plastic.
